(19) United States
(12) Patent Application Publication
(10) Pub. No.: US 2008/0028799 A1
(43) Pub. Date: Feb. 7, 2008

(54) Optical fiber preform manufacturing method

(75) Inventors: Young-il Kwon, Seoul (KR); Seok-woo Hwang, Anyang-shi (KR); Lae-hyuk Park, Seoul (KR); Soon-il Shon, Gwangmyung-shi (KR)

Correspondence Address: Harold L. Novick;The Nath Law Group PLLC, 112 South West St., Alexandria, VA, 22314, US

(73) Assignee: LG Cable LTD.

(21) Appl. No.: 11/704,976

(22) Filed: Feb. 12, 2007

(30) Foreign Application Priority Data
Nov. 5, 2001 (KR) 2001-68672

(51) Int. Cl. C03B 37/018

(52) U.S. Cl. 65/417

(57) ABSTRACT

The present invention relates to an optical fiber preform manufacturing method which can be used for wide band optical fibers by preventing the loss by OH-ions in the 1385 nm wavelength region by depositing a clad layer at a large thickness, so that the ratio of the outer diameter of a core to the outer diameter of a deposited clad is more than 2.5 after a collapse at the deposition of a clad layer and a core, and etching them respectively after the deposition and collapse, in order to prevent OH-ions contained in a tube and OH-ions penetrated into the surface by a hydrogen-oxygen burner from being diffused into the core in the deposition and collapse process in manufacturing an optical fiber preform by the MCVD method.

### CROSS-REFERENCE TO RELATED APPLICATIONS

This application is a continuation application of and claims the benefit of co-pending U.S. application Ser. No. 10/285,569 filed Nov. 1, 2002, the contents of which are incorporated herein by reference.

### BACKGROUND OF THE INVENTION

1. Field of the Invention

The present invention relates to an optical fiber preform manufacturing method, and more particularly, to an optical fiber preform manufacturing method which can be used for wide band optical fibers by preventing the loss by OH-ions in the 1385 nm wavelength region by depositing a clad layer at a large thickness, so that the ratio of the outer diameter of a core to the outer diameter of a deposited clad is more than 2.5 after a collapse at the deposition of a clad layer and a core, and etching them respectively after the deposition and collapse, in order to prevent OH-ions contained in a tube and OH-ions penetrated into the surface by a hydrogen-oxygen burner from being diffused into the core in the deposition and collapse process in manufacturing an optical fiber preform by the MCVD method.

2. Description of the Related Art

An optical fiber is a wave-guide of a fiber shape for light transmission, said optical fiber being made mainly of glass with an excellent transparency and having a structure of a double cylindrical shape in which a portion corresponding to a core is covered by a portion corresponding to a cladding. To protect the optical fiber from an impact, synthetic resin is coated on the outside thereof once or twice.

Additionally, since the refractive index of the core is higher than that of the cladding, light is concentrated on the core to be proceeded without a leakage. The optical fiber whose core has a diameter of several μm is referred to as a single-mode optical fiber, and the optical fiber whose core has a diameter of scores of μm is referred to as a multi-mode optical fiber. The optical fiber is divided into cascade and graded optical fibers according to the distribution of the refractive index of the core.

The optical fiber has no risk of interference or cross talk caused by external electromagnetic waves and overhearing. In addition, it is compact and lightweight, flexible, can contain a great number of communication lines in one optical fiber, and is strong to changes in external environments. Moreover, the raw material of glass which is a material of the optical fiber is very abundant, so the optical fiber is highly utilized.

To manufacture such an optical fiber, since the optical fiber is of a very thin thread shape, it is not manufactured directly, but it is made by forming an intermediate material corresponding to an optical fiber preform in the same structure as the optical fiber and melting and stretching it by a high heat.

Accordingly, since the optical fiber preform has the same structure as the optical fiber, it is formed in a double cylindrical shape in which the portion corresponding to the core is covered by the portion corresponding to the cladding.

In the method for manufacturing an optical fiber preform, the preform is obtained by attaching several tens of silicon oxide layers that are synthesized with germanium, boron, phosphor and the like by flame hydrolysis to the inside (the MCVD: Modified Chemical Vapor Deposition) or outside (the OVD: Outside Vapor Phase Deposition) of a proper attached member (graphitic or chinaware rod or a quartz tube of high purity) while rotating the attachment in an axial direction, and then heating and contracting it gradually by flames of a high temperature of more than 1700° C. At this time, the refractive index distribution of the preform can be adjusted arbitrarily by adjusting the containing amount of elements including germanium. This process is performed very carefully since the optical properties such as the loss of optical fibers is determined almost in this process. In addition, the VAD (Vapor Phase Axial Deposition) method for growing a preform directly at the end of a quartz rod is also employed.

Among them, the present invention relates to the MCVD method. As illustrated in FIG. 1 showing the structure of a general optical fiber preform manufactured by the MCVD method and FIG. 2 that is a flow chart for explaining a method for manufacturing a general optical fiber by the MCVD method using a conventional gas burner, the MCVD method includes the steps of: mounting a tube 1 on a deposition rack (not shown); depositing a clad layer 2 and a core 3 inside the tube by using a hydrogen-oxygen gas burner installed at the exterior of the tube while supplying a predetermined flow quantity of deposition gas (SiCl₄, GeCl₄, etc.) to the inner surface of the tube by the already known method; and collapsing the deposited tube (clad layer and the core) by heating the same by using the hydrogen-oxygen burner or a furnace heat source.

At this time, in the step of depositing a clad layer/core, OH-ions contained in the tube 1 are diffused into the clad layer 2 and the core 3 due to a high deposition temperature formed by an external heat source. In addition, in the step of deposition using the hydrogen-oxygen burner, new OH-ions are included in the outer surface layer of the tube 1 by incomplete chemical reaction of hydrogen and oxygen. As the deposition proceeds, the OH-ions are diffused into the inner surface of the tube 1.

Moreover, also in the step of collapse by using the hydrogen-oxygen burner, OH-ions are formed on the surface layer of the tube 1 and are diffused into the deposition layer simultaneously with the proceeding of the collapse by the same reason as in the deposition.

Although methods for manufacturing an optical fiber by the above-mentioned MCVD method have been studied actively, the manufacture of wide band optical fibers by the MCVD method has been restricted in manufacturing a preform by the MCVD method because the OH loss in a specific wavelength region (1385 nm) has occurred due to the limitation of this method, that is, the problem that the OH-ions contained in the tube and the OH-ions generated through a heat source using the hydrogen-oxygen gas burner are diffused into the core. In other words, there are a problem that the OH-ions contained in the tube cannot be prevented from being diffused into the core in the deposition, though the amount thereof is small. Furthermore, when a clad layer having a relatively low refractive index and a core having a refractive index slightly higher than that of the clad layer in the tube by using the hydrogen-oxygen burner in order, there is a problem that the OH-ions penetrated into the surface by the hydrogen/oxygen gas burner cannot be prevented from being diffused into the core while being diffused into the tube in the deposition step.

Hence, the OH-ions are penetrated into the core to thus cause a loss of light transmitted in the optical fiber (in the optical properties of the core) in a specific wavelength region of 1385 nm.

### SUMMARY OF THE INVENTION

It is, therefore, an object of the present invention to provide an optical fiber preform manufacturing method which can manufacture a wide band optical fiber by the MCVD method by preventing OH-ions from being diffused into a core in manufacturing an optical fiber preform by the MCVD method.

To achieve the above object, in manufacturing an optical fiber preform by the MCVD method, there is provided an optical fiber preform manufacturing method according to the present invention, comprising the steps of: mounting a tube on a deposition rack; depositing a clad layer and a core by using a hydrogen-oxygen gas burner installed at the exterior of the tube while supplying a predetermined flow quantity of deposition gas (SiCl₄, GeCl₄ and the like) into the inner surface of the tube; firstly etching the surface of the tube whose deposition is finished after removing the tube from the deposition rack and sealing both ends thereof; re-mounting the etched tube on the deposition rack; removing again impurities and moisture in the tube by heating the tube; collapsing the tube from which the impurities and moisture are removed in the above step; and secondly etching the surface of the tube whose collapse is finished.

Particularly, in the step of depositing a clad layer and a core, they are deposited such that the ratio of the outer diameter of the deposited clad layer to the outer diameter of the core is more than 2.5.

In addition, in the first surface etching step, one end portion of the tube whose deposition is finished is sealed by applying heat, and the other end portion thereof is sealed with a washed Teflon® (DuPont, Wilmington, Del.) (polytetrafluoroethylene) plug directly after it is separated from the rack.

Meanwhile, the first surface etching step and the second surface etching step are performed by the wet etching using fluorine acid and the like or the dry etching using high temperature plasma flames.

Meanwhile, in the impurities and moisture removal step, the impurities and moisture are removed by supplying a predetermined amount of chlorine gas into the tube in a state that the inside of the tube is heat at 1000˜1200° C. by the hydrogen-oxygen gas burner or a furnace heat source.

According to the present invention, the diffusion of OH-ions into the core is prevented in manufacturing an optical fiber preform and hence the loss by the OH-ions in a specific region is prevented, so a wide band optical fiber can be manufactured by the MCVD method.

### BRIEF DESCRIPTION OF THE DRAWINGS

The above objects, features and advantages of the present invention will become more apparent from the following detailed description when taken in conjunction with the accompanying drawings, in which:

FIG. 1 is a view illustrating the structure of a general optical fiber preform manufactured by the MCVD method;

FIG. 2 is a flow chart explaining a method for manufacturing a general optical fiber preform by the MCVD method using a gas burner according to the conventional art; and

FIG. 3 is a flow chart explaining a method for manufacturing an optical fiber preform by the MCVD method according to the present invention.

### DETAILED DESCRIPTION OF THE PREFERRED EMBODIMENT

A preferred embodiment of the present invention will now be described with reference to the accompanying drawings.

In the following description, same drawing reference numerals are used for the same elements even in different drawings. The matters defined in the description such as a detailed construction and elements of a method are nothing but the ones provided to assist in a comprehensive understanding of the invention.

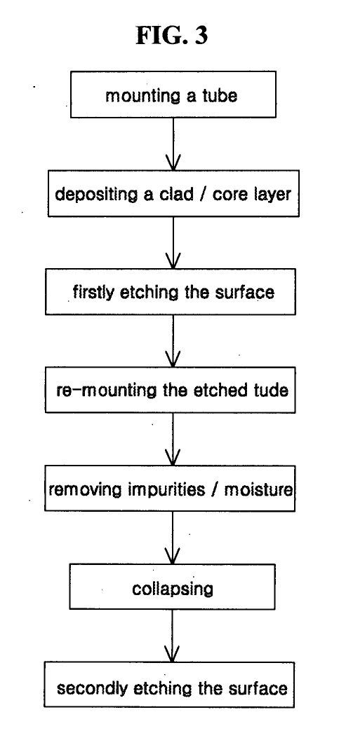

FIG. 3 is a flow chart explaining a method for manufacturing an optical fiber preform by the MCVD method according to the present invention.

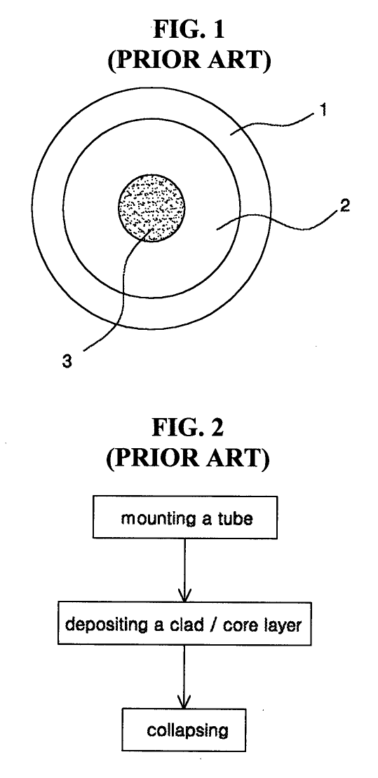

The structure of an optical fiber preform is the same as the structure of a general optical fiber preform as shown in FIG. 1. That is, the optical fiber preform is formed in a double cylindrical shape such that a tube 1 formed at the outermost wall covers a clad layer 2 and a core 3 formed inside.

In forming the thusly formed optical fiber preform, in the present invention, firstly, the tube 1 is mounted at the deposition rack (not shown). At this time, it is preferable that the tube containing OH-ions of less than 10 ppb is used.

When the tube 1 is mounted on the rack, a clad layer 2 and a core 3 are deposited inside the tube 1 in order by using a hydrogen-oxygen gas burner installed at the exterior of the tube 1 while supplying a predetermined flow quantity of deposition gas (SiCl₄, GeCl₄, etc.) to the inner surface of the tube 1 by the already known method.

As a gas used for deposition and an oxygen gas for delivery, of course, it is necessary to use purified gas with an extremely small amount of OH-ions.

At this time, the OH-ions contained in the tube 1 and the OH-ions penetrated into the tube 1 by the hydrogen-oxygen burner are penetrated into the core 3 by diffusion. To prevent this, the clad layer 2 is deposited at a large thickness in the deposition of the clad layer 2 and core 3. Preferably, the clad layer 2 is deposited such that the ratio of the outer diameter of the clad layer 2 to the outer diameter of the core 3 remains more than 2.5 after the collapse, and such that the ratio of the outer diameter of the clad layer 2 to the outer diameter of the core 3 exceeds 2.5 sufficiently at the deposition.

After the deposition of the clad layer 2 and the core 3, a first surface etching is performed before the collapse in a state that one end of the tube 1 whose deposition is finished is sealed by applying heat, and the other end thereof is sealed with a washed Teflon plug directly after it is separated from the rack.

At this time, any one of wet etching using fluorine acid and the like or dry etching using high temperature plasma flames can be selected.

The tube 1 whose etching is finished after the deposition is re-mounted on the rack.

With respect to the tube 1 mounted on the rack, in order to remove impurities or moisture in the tube 1 completely, a predetermined amount of chlorine gas and the like is supplied into the tube 1 in a state that the inside of the tube 1 is heated at an adequate temperature (approximately 1000˜1200° C.) by using the hydrogen-oxygen gas burner or a furnace heat source.

When the impurities in the tube 1 are completely removed, a collapse is performed again by heating the tube 1 by using the hydrogen-oxygen gas burner or the furnace heat source.

At this time, also in the collapse using the hydrogen-oxygen gas burner, OH-ions are formed on the surface layer and hence are diffused into the tube 1 simultaneously with the proceeding of the collapse by the same reason as in the deposition. Thus, when the collapse is finished, the OH-ions penetrated into the surface of the tube 1 are removed by performing the wet etching or dry etching in the same manner as the etching method that has been used after the deposition. Particularly, also in the collapse by the furnace heat source, since materials formed by the corrosion of the heat source can be attached to the surface of the preform, it is preferred that the wet etching is performed for removing those materials.

That is, when the optical fiber preform is manufactured by the optical fiber preform manufacturing method of the present invention, the clad layer 2 and the core 3 are deposited in order by the hydrogen-oxygen gas burner installed at the exterior of the tube 1 while supplying a predetermined flow quantity of deposition gas (SiCl₄, GeCl₄, etc.) to the inner surface of the tube 1 by the already known method, in a state that the tube 1 containing a small amount of OH-ions (approximately 10 ppb) is mounted at the deposition rack.

In this deposition process, the OH-ions contained in the tube 1 are diffused into the deposition layer due to a high deposition temperature formed by an external heat source. In addition, during the process of deposition using the hydrogen-oxygen gas burner, new OH-ions are formed on the outside surface of the tube 1 by incomplete chemical reaction of hydrogen and oxygen, and are diffused into the inner surface of the tube 1 as the deposition proceeds.

However, in the present invention, to minimize the effect by the diffusion of the OH-ions contained in the tube 1 and the OH-ions penetrated into the tube 1 by the hydrogen-oxygen gas burner, the clad layer 2 is deposited at a large thickness in the deposition of the clad layer 2 and the core 3, so the OH-ions cannot be penetrated deeply into the core 3 (the tube 1), but are distributed mainly on the surface.

The OH-ions penetrated during the deposition by the hydrogen-oxygen gas burner are diffused further as the process (collapse, second tube junction, drawing and the like) proceeds and resultantly are penetrated into the core. Hence, in the present invention, after the deposition, the OH-ions on the surface of the tube penetrated by the hydrogen-oxygen burner are completely removed before the collapse by the wet etching using fluorine acid and the like or the dry etching using high temperature plasma flames, in a state that one end of the tube 1 whose deposition is finished is sealed by applying heat, and the other end thereof is sealed with a washed Teflon® (DuPont, Wilmington, Del.) (polytetrafluoroethylene) plug directly after it is separated from the rack.

Therefore, in a state that the OH-ions penetrated in the deposition step are removed, the next step of manufacturing can be performed.

The tube 1 that is etched as above after the deposition is re-mounted on the rack, and then the impurities and moisture in the tube 1 are completely removed while supplying a predetermined amount of chlorine gas and the like into the tube 1 in a state that the inside of the tube 1 is heated at an adequate temperature (approximately 1000˜1200° C.) by using the hydrogen-oxygen gas burner or the furnace heat source.

Also, at this time, since the OH-ions distributed mainly on the surface are removed after the deposition, the OH-ions are not diffused inside the tube 1.

When the impurities and the like in the tube 1 are completely removed in the above step, the collapse is performed again by using the hydrogen-oxygen gas burner or the furnace heat source.

At this time, in the collapse using the hydrogen-oxygen gas burner, OH-ions are formed on the surface layer and are diffused thereinto simultaneously with the proceeding of the collapse by the same reason as in the deposition. When the collapse is finished, the OH-ions penetrated into the surface are removed by the wet etching or the dry etching in the same manner as the etching method used after the deposition, so an optical fiber preform containing a small amount of OH-ions are provided in the further process (second tube junction, drawing and the like).

Accordingly, when the optical fiber preform is manufactured in the above-described method, it is possible to prevent the diffusion of OH-ions into the core in manufacturing the optical fiber preform, thus making it possible to manufacture an wide band optical fiber preform by the MCVD method.

As described above, the present invention has an advantage that it can be used for wide band optical fibers by preventing the loss by OH-ions in the 1385 nm wavelength region by depositing a clad layer at a large thickness, so that the ratio of the outer diameter of a core to the outer diameter of a deposited clad is more than 2.5 after a collapse at the deposition of a clad layer and a core, and etching them respectively after the deposition and collapse, in order to prevent OH-ions contained in a tube and OH-ions penetrated into the surface by a hydrogen-oxygen burner from being diffused into the core in the deposition and collapse process in manufacturing an optical fiber preform by the MCVD method.

What is claimed is:

1. In manufacturing an optical fiber preform by the MCVD method, an optical fiber preform manufacturing method, comprising the steps of:
mounting a tube on a deposition rack;
depositing a clad layer and a core by using a hydrogen-oxygen gas burner installed at the exterior of the tube on the deposition rack while supplying a predetermined flow quantity of deposition gas into the inner surface of the tube;
completing deposition of the clad layer and the core;
removing the tube with the clad layer and the core deposited thereon from the deposition rack and sealing both ends thereof;
etching the outer surface of the tube to remove impurities from the outer surface of the tube with the sealed ends;
re-mounting the etched tube on the deposition rack;
removing impurities and moisture in the etched tube by heating the tube;
collapsing the tube from which the impurities and moisture are removed in the above step to form the fiber optic preform; and
further etching the outer surface of the fiber optic preform after the collapse is finished.

2. The method of claim 1, wherein, in the step of depositing a clad layer and a core layer, they are deposited such that the ratio of the outer diameter of the deposited clad layer to the outer diameter of the core is more than 2.5:1 after the step of collapsing the tube.

3. The method of claim 1, wherein, prior to the first outer surface etching step, one end portion of the tube whose deposition is finished is sealed by applying heat, and the other end portion thereof is sealed with a washed polytetrafluroethylene plug directly after it is separated from the rack.

4. The method of claim 1, wherein the first outer surface etching step and the second outer surface etching step are performed by wet etching using fluorine acid or dry etching using high temperature plasma flames.

5. The method of claim 1, wherein, in the impurities and moisture removal step, the impurities and moisture are removed by supplying a predetermined amount of chlorine gas into the tube in a state that the inside of the tube is heated to 1000˜1200° C. by the hydrogen-oxygen gas burner or the furnace heat source.
